(19) United States
(12) Patent Application Publication
(10) Pub. No.: US 2025/0100358 A1
(43) Pub. Date: Mar. 27, 2025

(54) SOFT TOP ASSEMBLY WITH LINKAGE FREE BOW SYSTEM

(71) Applicant: Bestop, Inc., Louisville, CO (US)

(72) Inventor: Tavis Lutzka, Rochester Hills, MI (US)

(73) Assignee: Bestop, Inc., Louisville, CO (US)

(21) Appl. No.: 18/897,814

(22) Filed: Sep. 26, 2024

Related U.S. Application Data
(60) Provisional application No. 63/585,455, filed on Sep. 26, 2023.
(60) Provisional application No. 63/590,243, filed on Oct. 13, 2023.
(60) Provisional application No. 63/593,924, filed on Oct. 27, 2023.

(51) Int. Cl. B60J 7/12

(52) U.S. Cl. CPC B60J 7/1278; B60J 7/1239; B60J 7/1247

(57) ABSTRACT

Soft top assembly which is linkage free between fabric management bows. A combination of a predetermined plurality of pivots, including at least one predetermined cooperative biasing pivot, dampens the movement of the soft top and provides an assist when moving between closed and predetermined open positions. Safety catches can be used if desired. An arm goes over center to lock the soft top assembly open even if there is no catch to hold the soft top in a sunroof open position. Front arm members can have an over-center position that substantially locks down the soft top in the open sunroof position from going backward until upward pressure is placed on the frame and then the soft top pivots back with an assist. A four-bar link system more easily moves the soft top to a stowed position with another push upward where a clock spring pivot biases the parallelogram frame back.

### CROSS-REFERENCE TO RELATED APPLICATIONS

This application is a Non-Provisional Patent Application which claims the benefit of U.S. Provisional Patent Application No. 63/585,455, filed Sep. 26, 2023, U.S. Provisional Patent Application No. 63/590,243, filed Oct. 13, 2023, and U.S. Provisional Patent Application No. 63/593,924, filed Oct. 27, 2023. The disclosures of the above applications are incorporated herein by reference.

### FIELD OF THE INVENTION

The present invention relates to a soft top assembly including a linkage-free bow system.

### BACKGROUND OF THE INVENTION

Foldable soft tops for sport utility vehicles are known in the art. These tops provide a vehicle with an open air experience with the top folded back or provide protection from the elements with the top unfolded forward. Such tops typically require the operator to perform a series of manipulation of the top, and management and stowage of the fabric materials of the top during folding.

Therefore, there remains a need in the art to provide a roof top opening cover providing efficient and easy opening/closing and improved fabric management.

### SUMMARY OF THE INVENTION

A fabric management soft top assembly which is linkage free between bows, e.g., fabric management bows, is provided in accordance with aspects of the present invention.

There is provided a soft roof top opening cover assembly which is linkage free between fabric management bows. A combination of a predetermined plurality of pivots, including at least one biasing pivot, dampens the movement of the soft top and provides an assist when moving between closed and at least one predetermined open position. An arm member can go over center to lock the soft top assembly open even if there is no catch to hold the soft top in a sunroof open position. Front arms can have an over-center position that substantially locks down the soft top in the open sunroof position from going backward until upward pressure is placed on the frame and then the soft top pivots back with an assist. A four-bar link system more easily moves the soft top generally rearward and down to a stowed position with another push upward where a clock spring pivot biases the soft top frame back.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein the figures show views of an SUV soft top assembly of the present invention.

FIGS. 1-5 and 24-28 depict a soft top assembly in accordance with the present invention, depicting the assembly in an exemplary closed position;

FIGS. 6-7 depict the assembly opening from the closed position, in accordance with the present invention;

FIGS. 12-15, 29-31, and 33-34 depict the assembly in an exemplary open sunroof position, in accordance with the present invention;

FIGS. 16-22 and 35 depicts the assembly moving into an exemplary stowed position, in accordance with aspects of the present invention;

FIG. 23 is a side elevation view depicting the exemplary stowed position, in accordance with aspects of the present invention;

FIG. 32 is a perspective view depicting an exemplary clock spring device for biasing pivot joints, in accordance with aspects of the present invention;

FIG. 36 is a side elevation view of a soft top assembly operable for a hardtop vehicle depicting a bow on an arm, in accordance with aspects of the present invention, the assembly depicted in an exemplary a closed position;

FIGS. 37-39 are side elevation views depicting the soft top assembly opening to an open sunroof position, in accordance with aspects of the present invention;

FIG. 40 is a side elevation view of the soft top assembly depicted in an exemplary open position, in accordance with aspects of the present invention;

FIG. 41 is a side elevation view of a soft top assembly operable for a hardtop vehicle depicting a bow on a base, in accordance with aspects of the present invention, the assembly depicted in an exemplary closed position;

FIGS. 42-44 are side elevation views depicting the soft top assembly opening to an open sunroof position, in accordance with aspects of the present invention; and

FIG. 45 is a side elevation view depicting the soft top assembly in an exemplary open position, according to aspects of the present invention.

### DETAILED DESCRIPTION OF THE PREFERRED EMBODIMENTS

Referring to the figures generally, a fabric management soft top assembly which is linkage free between the bows is provided in accordance with the present invention.

While a two-door sport utility vehicle (SUV) top is depicted, it is understood that the assembly 20 is operably adapted for 4-door SUV's and any SUV, e.g., SUV including or not including front and/or rear sport bars, roll bars, etc. This system is also operably adapted to be used in a sunroof for hardtop™ top, filling the freedom panel area of a Jeep™ type vehicle. The hardtop and system are in sealing engagement, and the system opens to at least the open sunroof position. The system is operably additionally openable to a stowage position, according to aspects of the present invention.

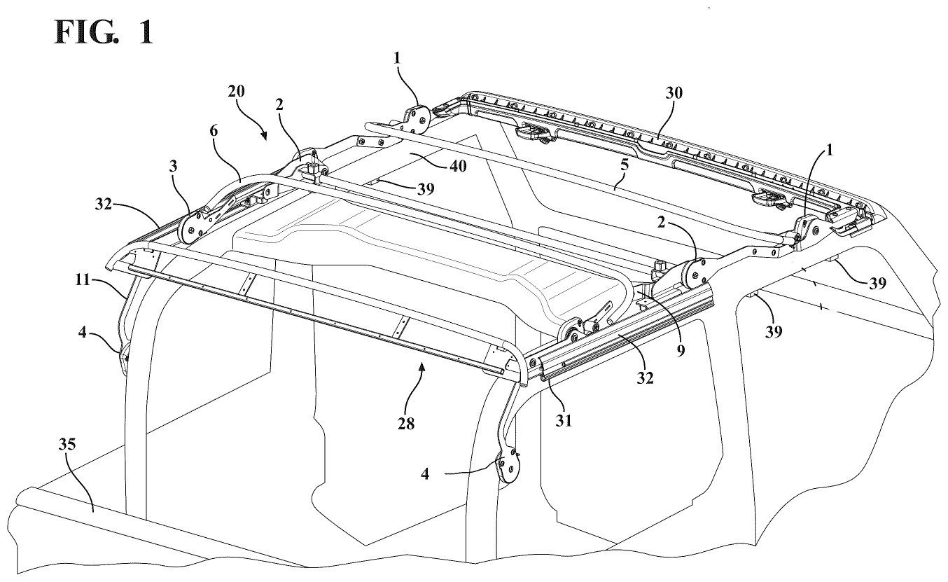

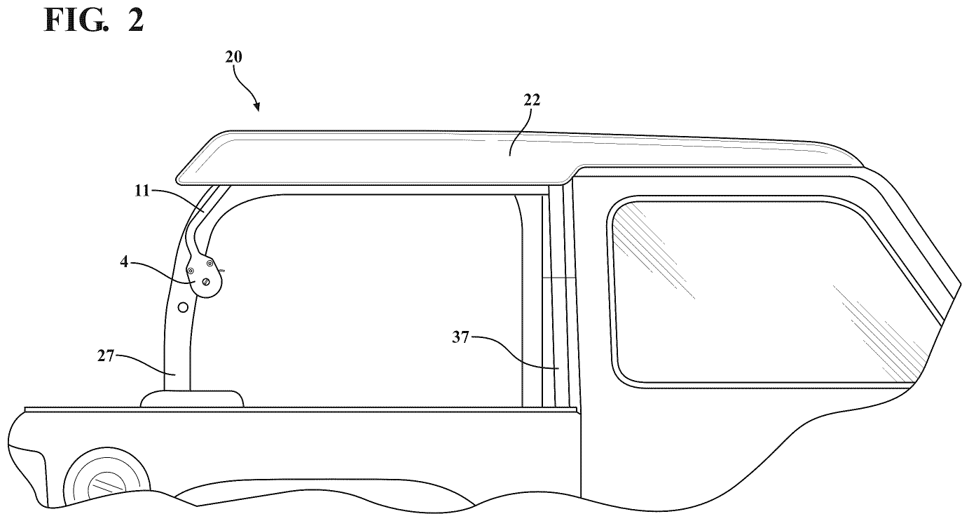

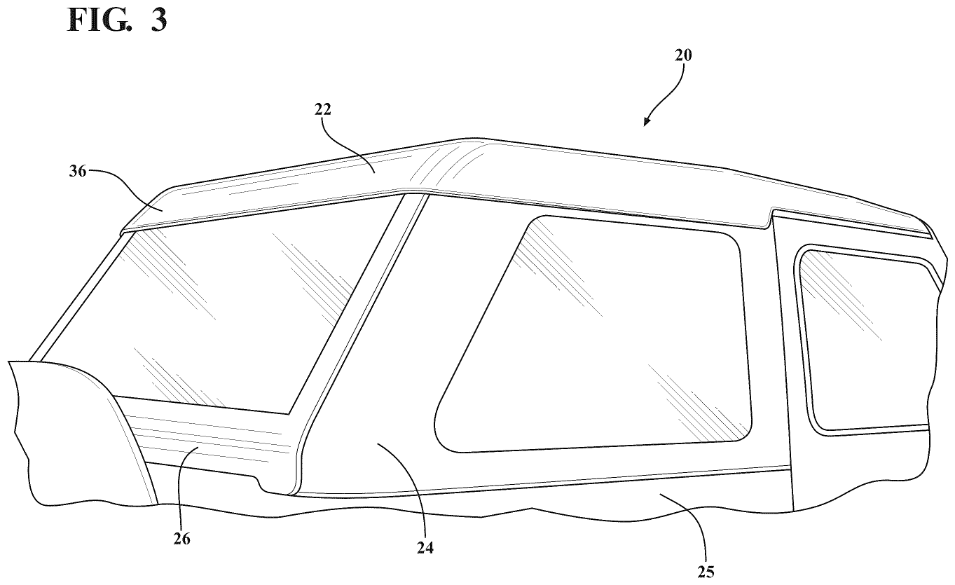

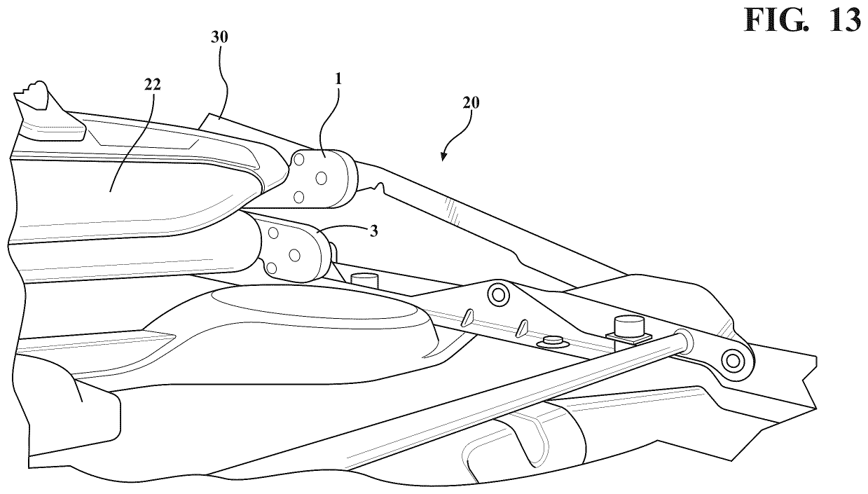

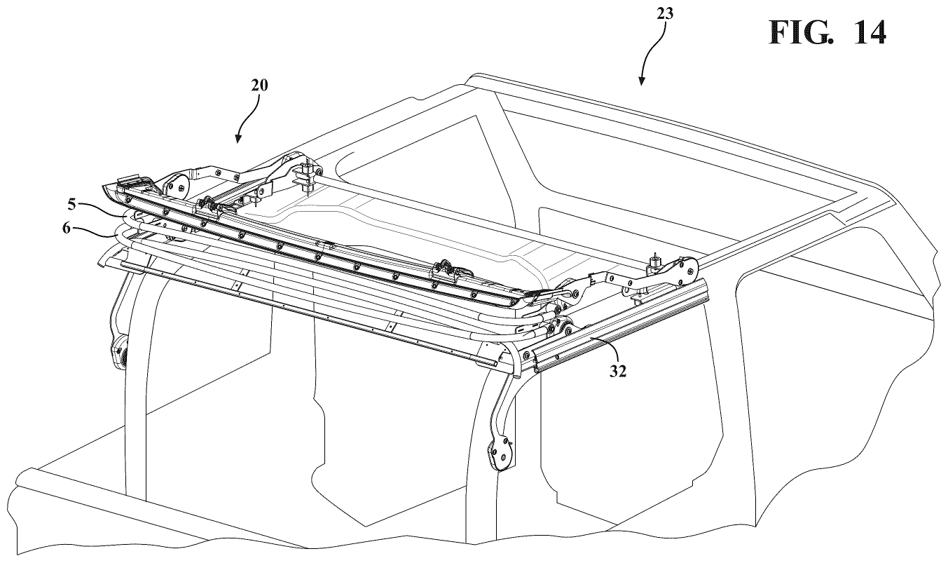

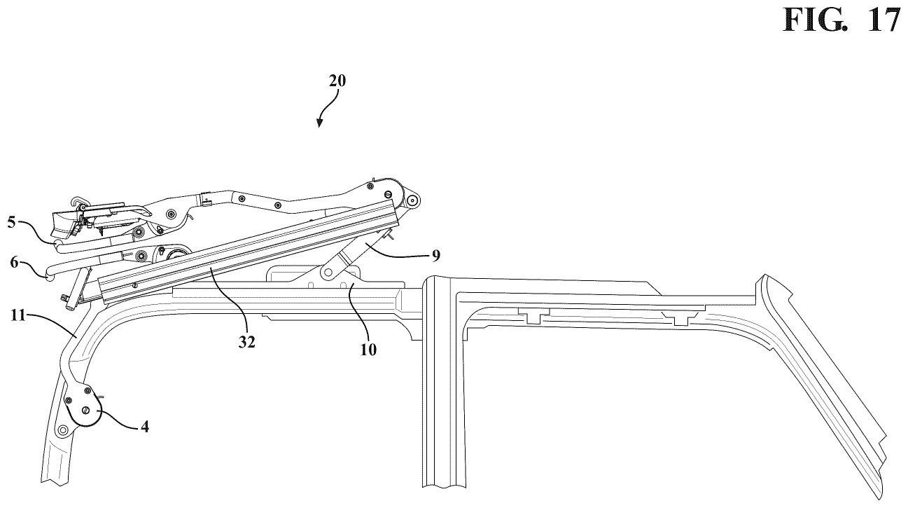

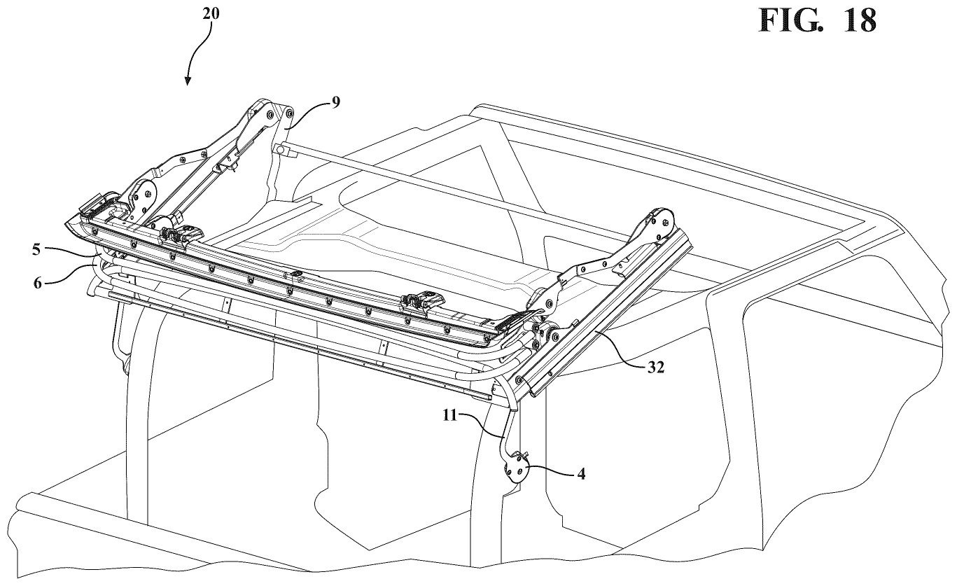

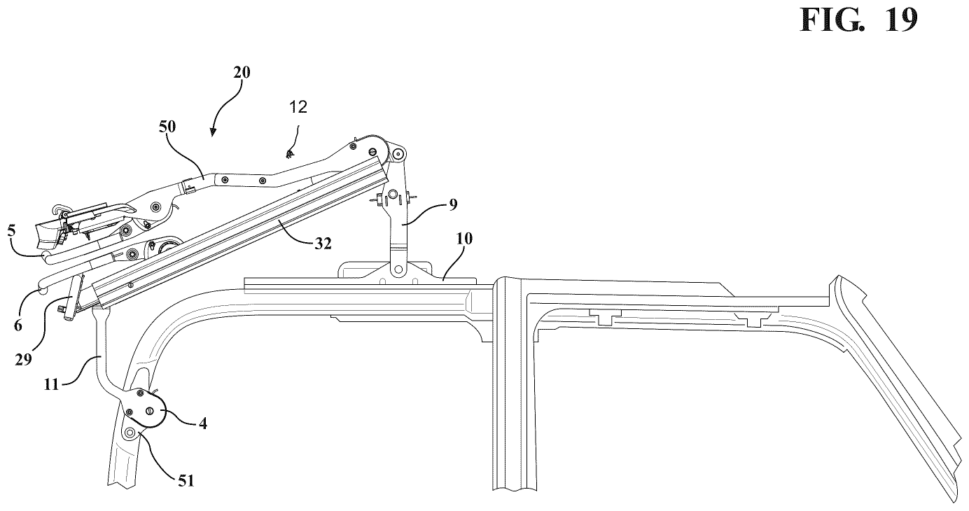

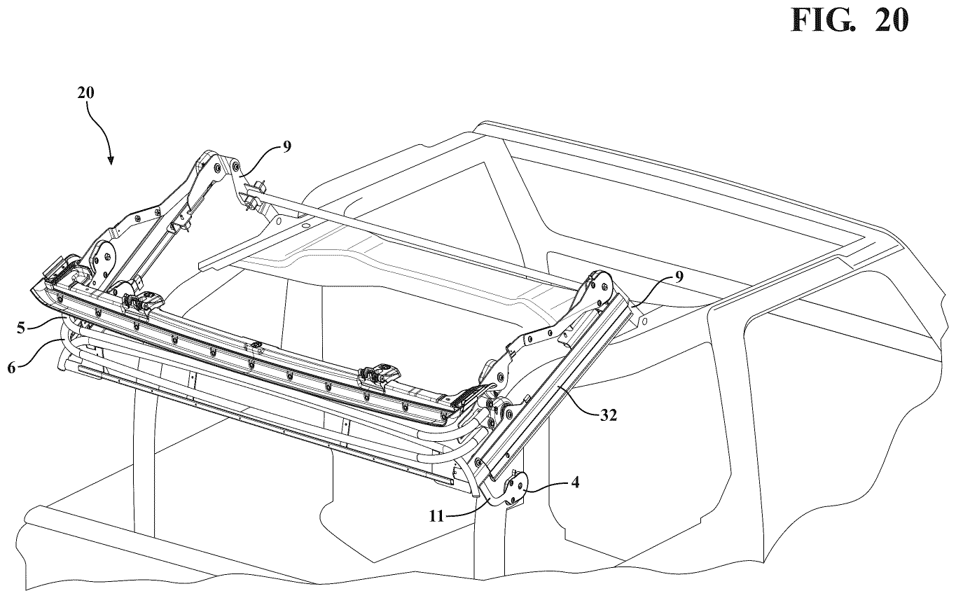

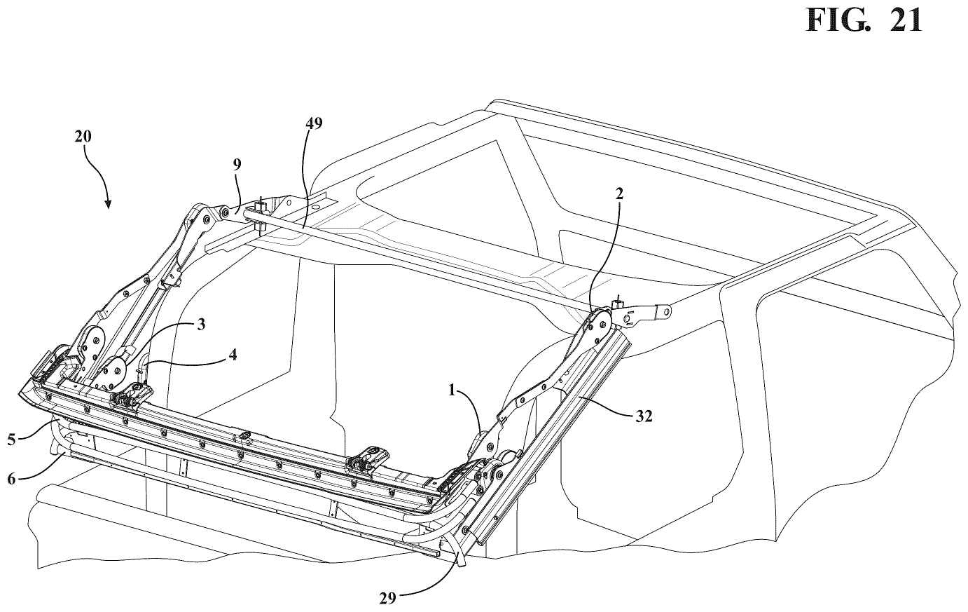

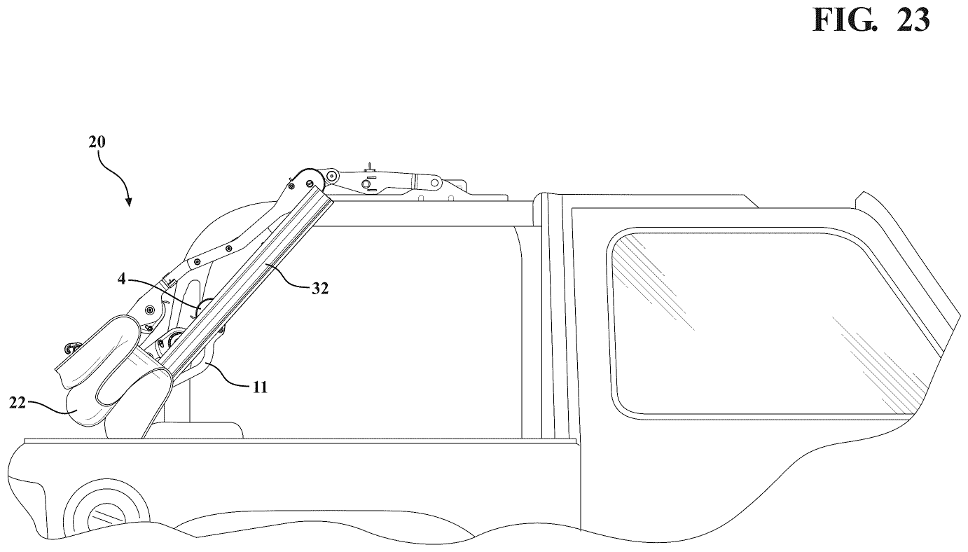

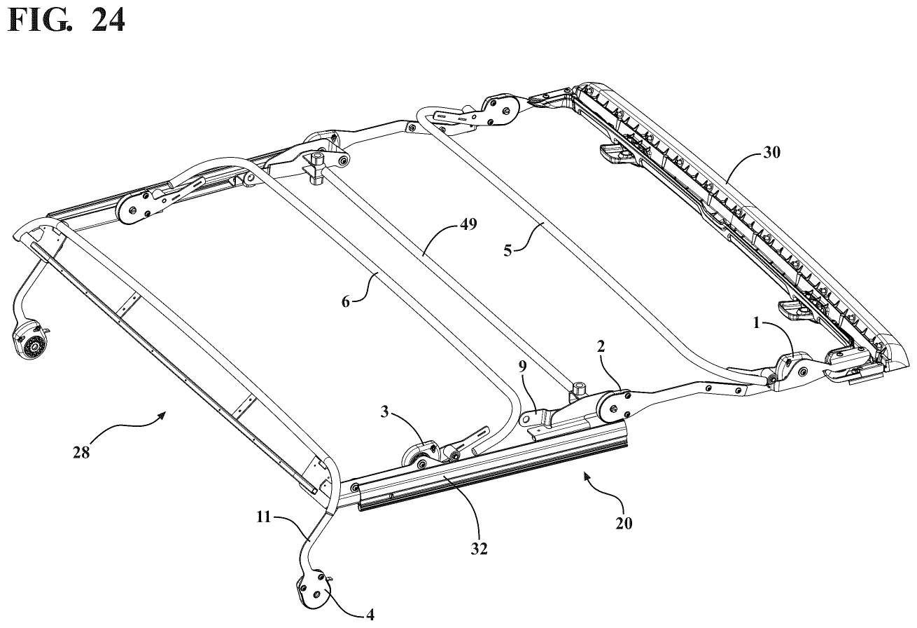

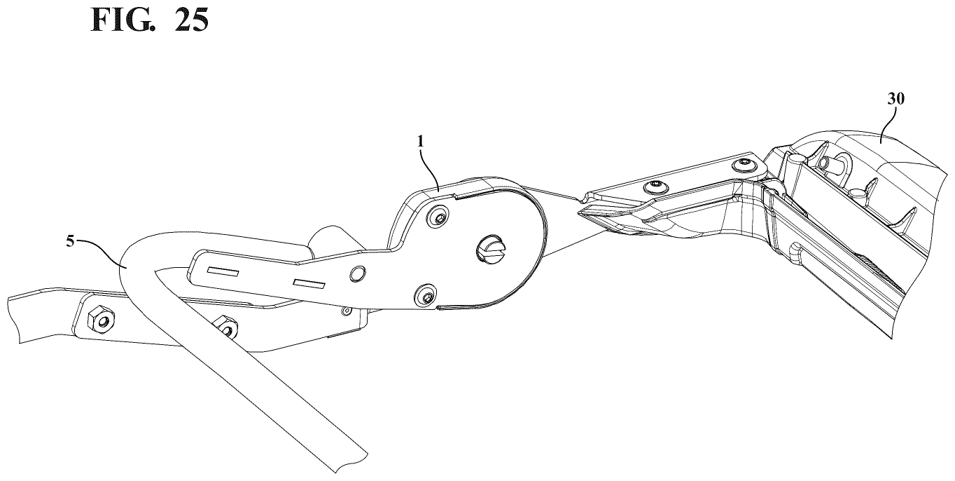

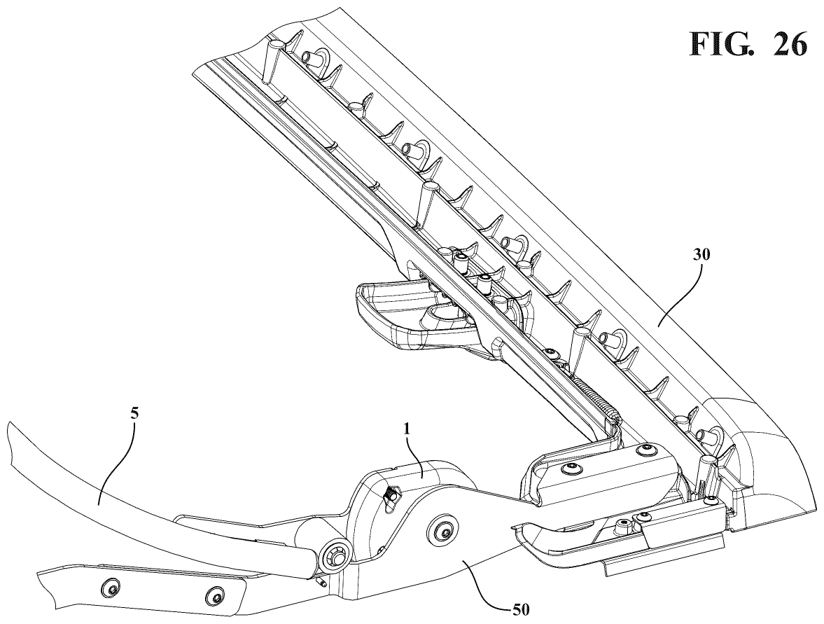

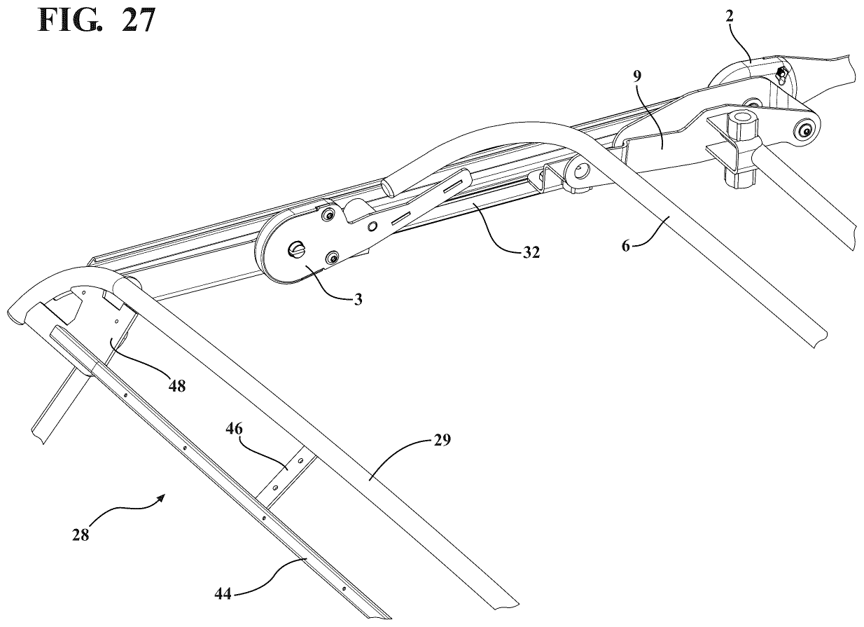

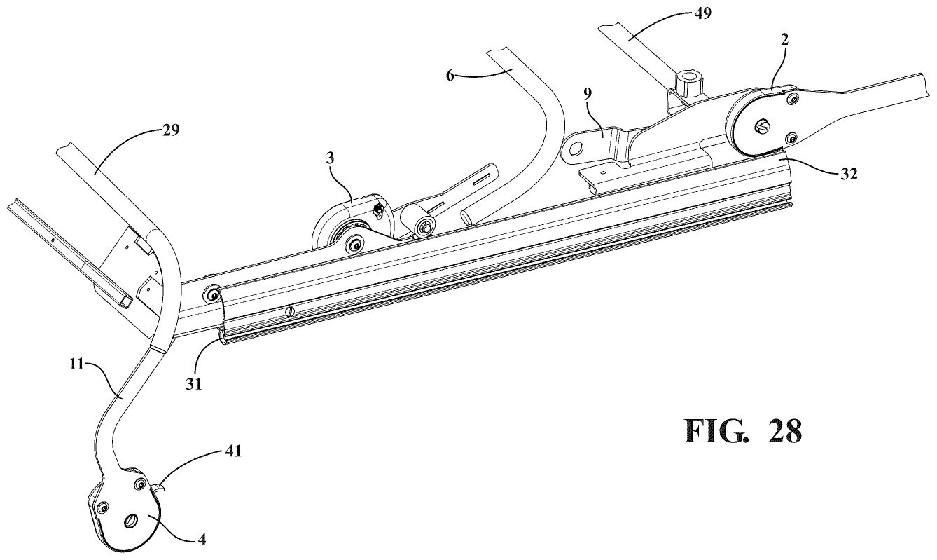

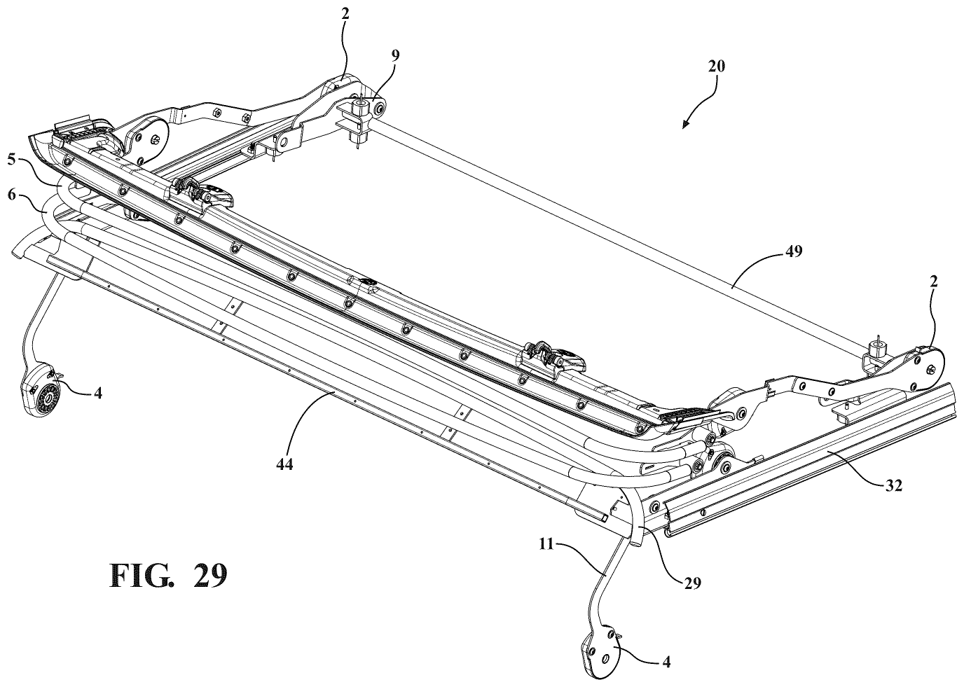

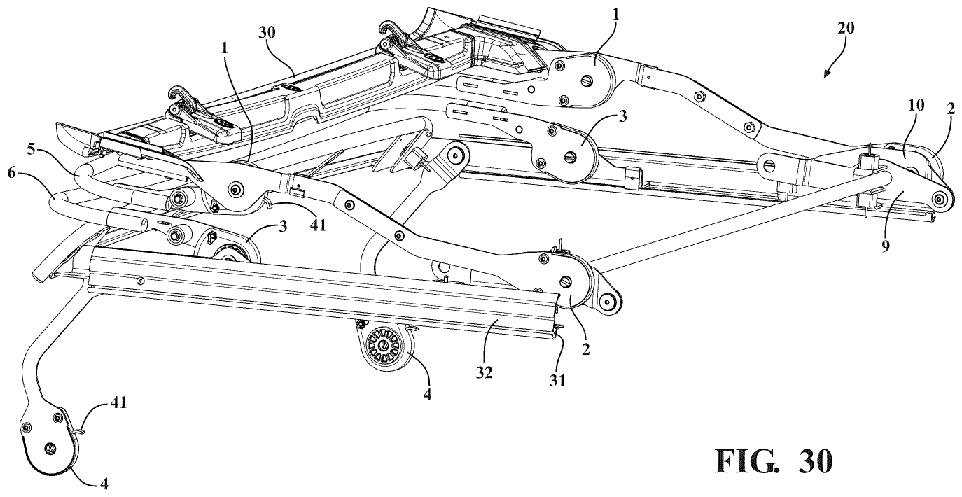

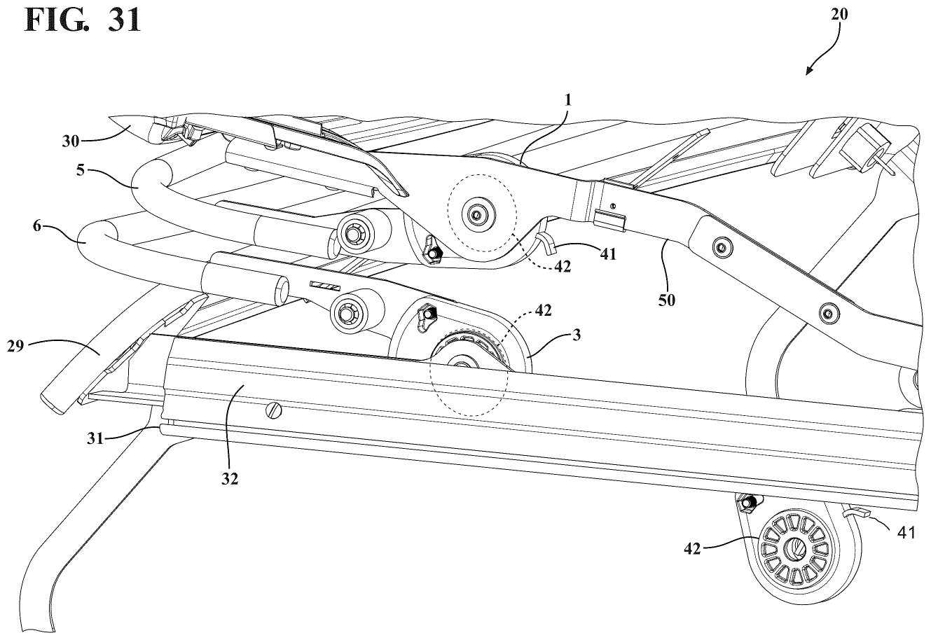

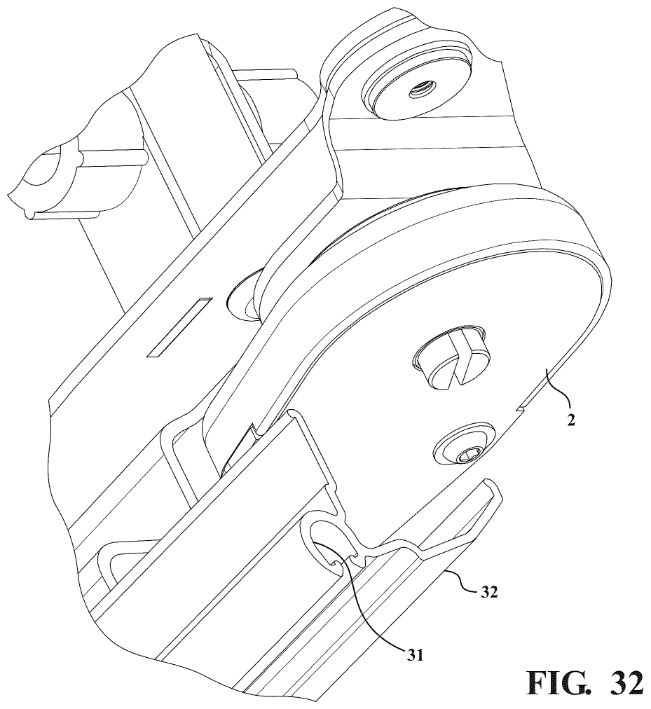

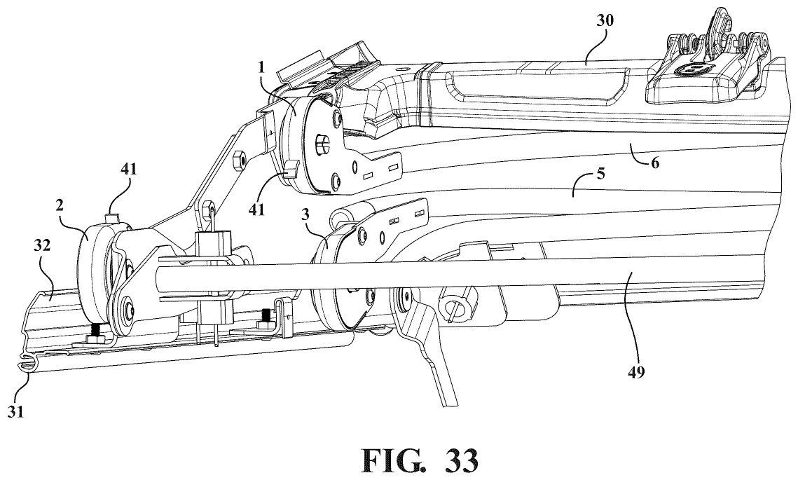

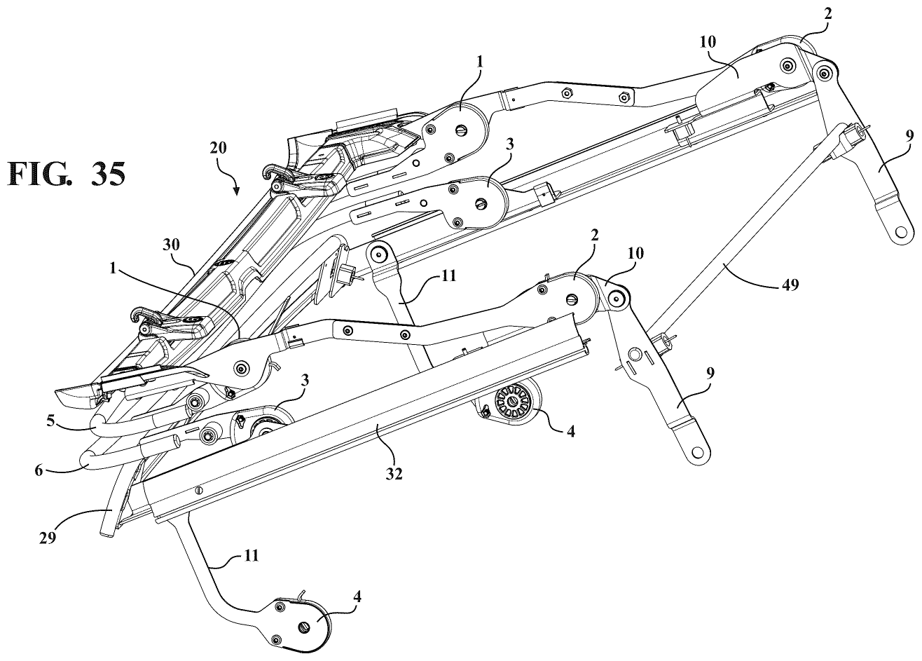

Referring to the Figures generally, and more particularly to FIGS. 1-35, there is provided a fabric management soft top assembly, indicated generally at 20, operably adapted to selectively close off/open up a predetermined roof top opening 23 of a vehicle 25, e.g., front cockpit, rear cockpit, cargo area. The fabric management soft top assembly 20 incorporates at least one pivotable portion 21 to open to at least the open sunroof position.

Each bow has a pivot 1 through 4 on either side (or preferably both sides) which all have a clock spring biasing generally in the direction of the arrows in the Figures. At rest, a front bow 5 and rear bow 6 are biased away from each other. The springs interact with respective predetermined loads. Alternative configurations, combinations, and biasing direction(s) or combinations are contemplated without departure from the scope of the present invention.

In a preferred embodiment, the front bow 5 and rear bow 6 are operably connected by straps 7 and 8 (e.g., fabric straps, soft webbing, woven polyester fabric, synthetic material, natural fabrics, etc.), which operably supports the soft cover 22, e.g., fabric cover material, sail material, etc., in the closed position. Straps 7,8 can be any suitable predetermined material.

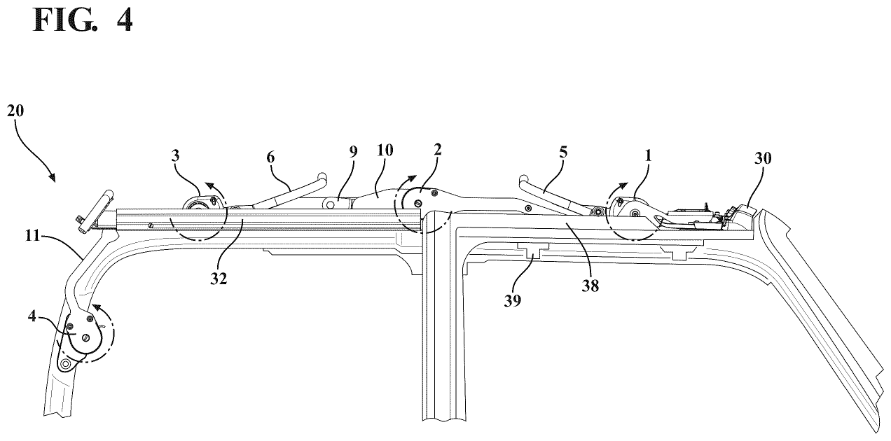

The soft top assembly 20 easily opens to an open sunroof position by pushing the pivotable portion 21 upward and the top assembly 20 tilts on pivots 1 and 3 back while pivot 2 dampens the movement and also provides an assist when closing. A plurality of arms 9, 10 and 11 (e.g., first link 9, second link, third link 11) along with a frame, indicated generally at 12, provide a four-bar link system which easily moves the top to a stowed position with another push generally upward where the clock spring pivot 4 biases the generally parallelogram frame back. From the position shown in FIG. 4, the first arm 9 member goes over center to lock the top 20/21 down even if there is no catch to hold the top there when in the sunroof open position. A simple pawl type safety catch can be used if desired. Also, the front arm members, e.g., 9, 10, etc., have an over-center position that operably locks down the top 20/21 in the open sunroof position from going backward until upward pressure is placed on the frame 12 and then the whole unit pivots back with an assist.

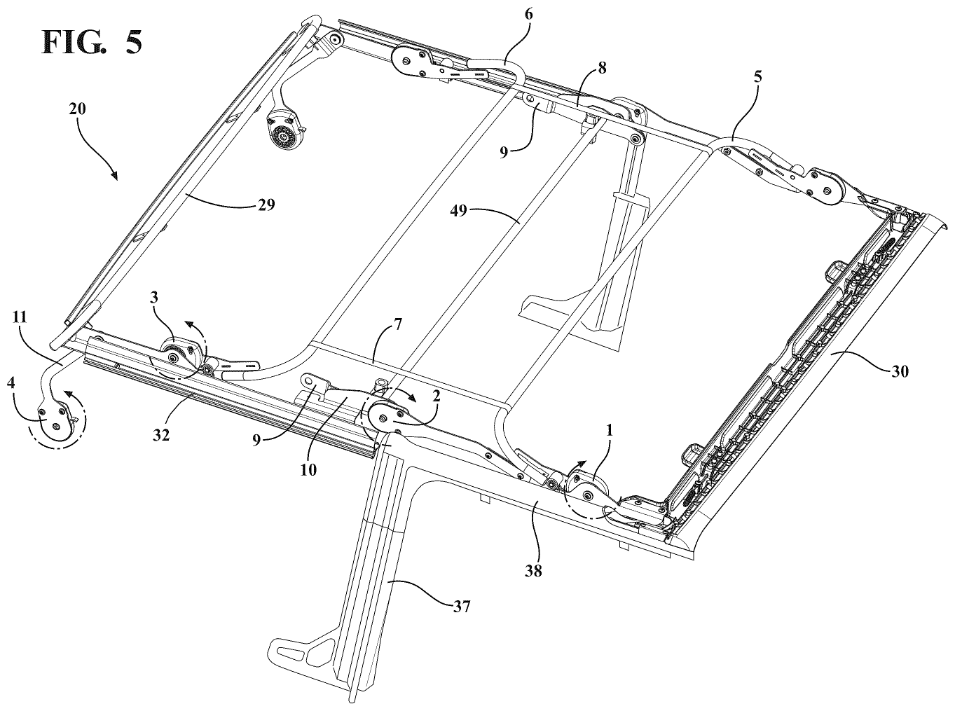

Referring to the drawings, e.g., FIGS. 4-5, clock springs 42 at pivots 1 and 3 are biased away from each other to maintain the cover 22 tension. In particular, the springs 42,42 help to load the bows (respective bows 5 and 6), and when the top is opening, the bows manage the fabric cover 22.

The clock spring 42 at pivot 2 is biased toward closing the top in order to dampen the fall of the top into the open sunroof position, and to assist the top balance when closing to the closed position.

The clock spring 42 at pivot 4 is biased to assist in closing the top from a stowed position. In particular, for assisting with lifting the convertible top, the spring 42 at pivot 4 simplifies the process of raising the top back up to the top of the vehicle.

The SUV top 20 includes a rear four-bar link arrangement to allow everything to operably parallelogram down into the stowed position with the cover 22 generally behind the rear sport bar 27, or generally behind other predetermined vehicle 25 structure, component, or area depending on the particular application.

No links between the fabric management bows. No spin riveting is necessary at any of the pivots. For example, preferably, according to aspects of the present invention, there is not a flared pin on both sides and that have to put a rivet in the joint and then on the other side use a spinner machine and spin and flare the other side because there is a lot of machine line up and assembly time involved. According to aspects of the present invention, bolts and a keyed member for keying the spring to the housing is used, in accordance with aspects of the present invention. A front header 30 comes to rest where it is supposed to (on typical roller track tops it could pull back a little making it hard to close at the front windshield frame). The cover 22 is operably selectively connected to the front header 30 and tensions the top in the closed position.

The assembly 20 is operably adapted to selectively couple to at least one pair of side windows 24, e.g., rear side windows, and a rear window 26 panel arrangements. The windows 24,24,26 are adapted to operably couple to the vehicle 25, and the windows are each selectively removable. By way of non-limiting example, the side and/or rear windows 24,24,26 are soft panel windows, or hard panels with glass. Alternative window attachment arrangements suitable to selectively removably coupled to the vehicle and top deck are contemplated depending on the application without departure from the scope of the present invention. Preferably, each side window 24 operably couples to at least one retention member 31, e.g., a channel, bulb-shaped channel, hook, j-retainer, or any other shape or feature suitable to receive and retain a corresponding operable attachment feature provided on the side windows 24, e.g., bulb extrusion, bulb retainer, flange, etc. Preferably, the retention member is provided on a rear rail 32. Alternatively, the attachment feature is located on the rear rails 32,32 and retention member 31 on the side windows 24,24. A top rear deck strip 36 is preferably operably adapted to couple to the rear window 26, e.g., with at least one retention member and cooperating attachment feature. Preferably, a rear door trim 35 operably connects the bottom of the rear window 26 to the vehicle adjacent a rear end opening into the vehicle 25.

According to aspects of the present invention, the assembly 20 includes at least one rear bow arrangement, indicated generally at 28, operable to set the top deck rear height and predetermined transition angle to the rear, e.g., transition to the rear window. A substantially vertical back or a predetermined angel amount from vertical are contemplated depending on the application without departure from the scope of the present invention. The rear bow arrangement includes at least one first rear bow 29 and at least one second rear bow 44 operably coupled with at least one link and/or bracket 46 and/or corner brackets 48,48.

At least one pair of rear door trims 37 can be provided operably connected to the vehicle and operably adapted to couple a front edge of the pair of side windows 24 to the vehicle.

The fourth pivot 4, e.g., rear pivot, is preferably operably coupled to a bracket 51 adapted to connect to the vehicle 35, e.g., to a cargo area sport bar 27. The third arm 11, e.g., rear link, is operably connected to pivot 4 and operably coupled to the pivotable portion 21. Preferably, a pair of third arms 11 are operably connected to a pair of pivots 4.

The bow 5, e.g., first fabric management bow, is operably coupled to the pivot 1, e.g., pair of pivots 1, operably coupled to a pair of front rails 50. Each front rail 50 is operably connected to the header 30, e.g., front bow 30.

The second bow 6, e.g., second fabric management bow, is operably coupled to the pivot 3, e.g., pair of pivots 3, operably coupled to the vehicle 32. The pivotable portion 21 is selectively rotated to the stowed position with pivots 3 and 4.

Referring to the figures generally, at least one pair of door rails 38, e.g., front cabin door rails, can be provided to operably connect the assembly 20 at a roof-top opening 23 of the vehicle, e.g., to the sport bars 40, with at least one fastener 39, e.g., clamp. Alternatively, the assembly 20 is operably adapted to couple at the roof-top opening of the vehicle without door rails. While sport bars 40 are described, it is understood that alternatively the vehicle may have no sport bars and the assembly 20 is operably adapted to connect to the vehicle at the roof-top opening.

An additional bow 49 is operably connected in the pivotable portion 21 in a cross-car position, preferably, operably coupled adjacent to the pair of arms 9, further providing easier movement of the top 10 between closed, open sunroof, and stowed positions and help prevent binding during operation as well as further stability.

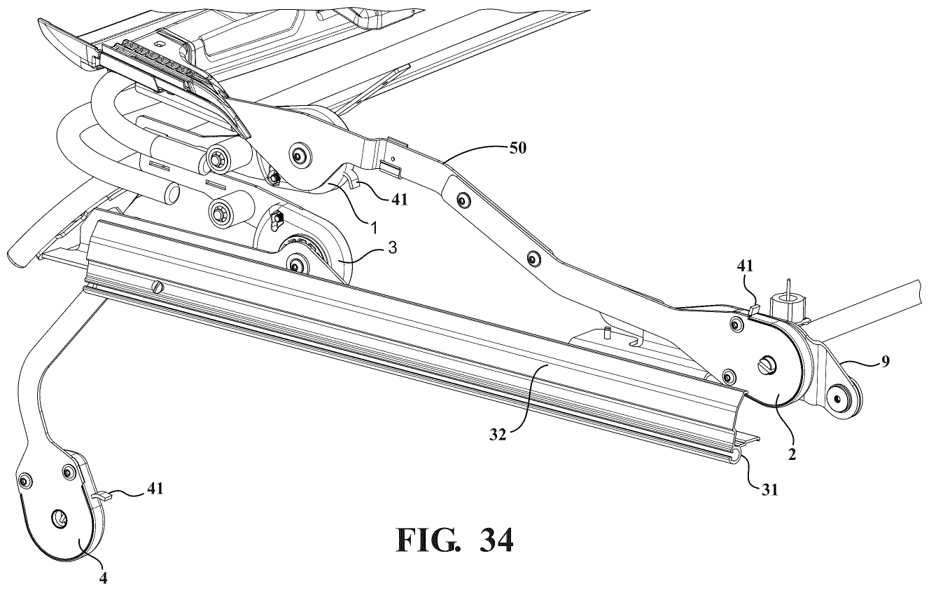

Any of the pivots 1 through 4 may also operably incorporate a predetermined release if desired, e.g., thumb tab catch release, 41 (e.g., FIG. 34). Pawl type safety catch(es) can be used if desired.

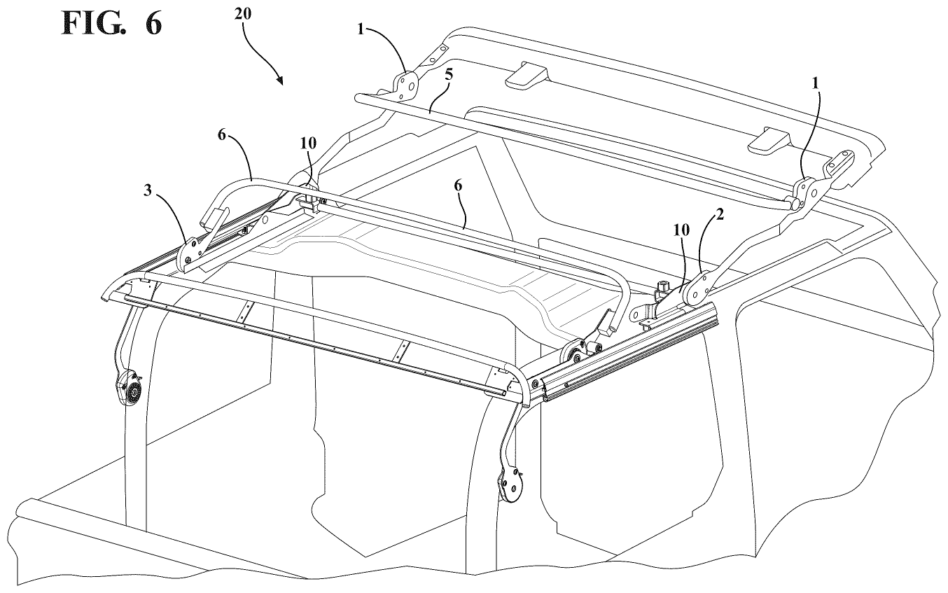

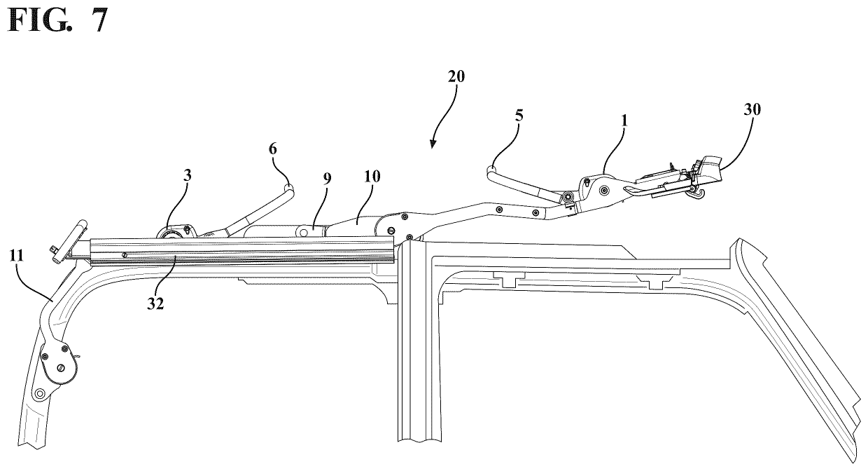

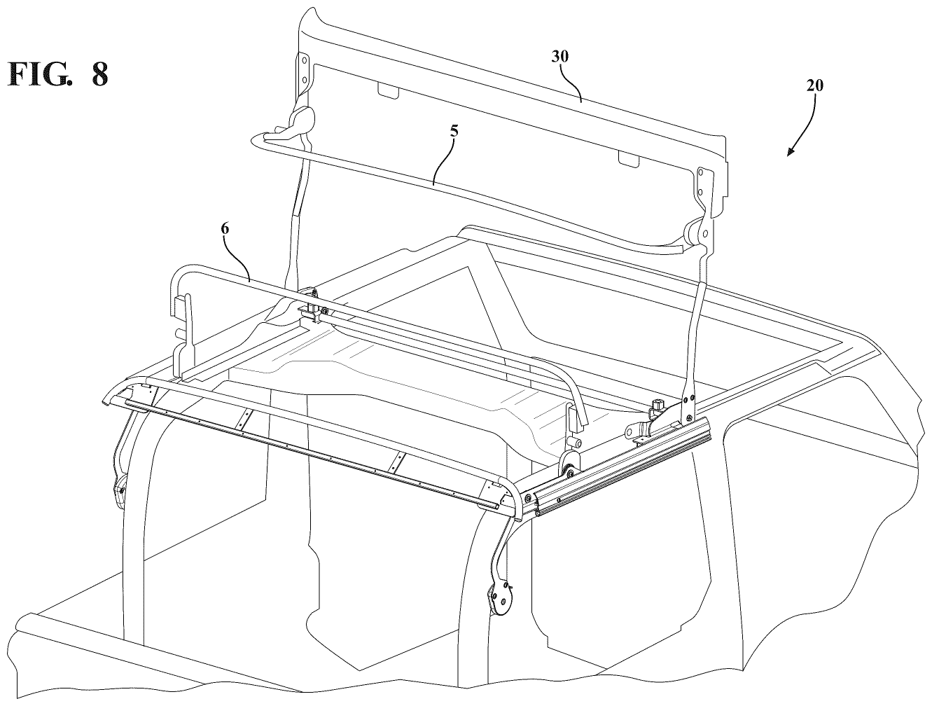

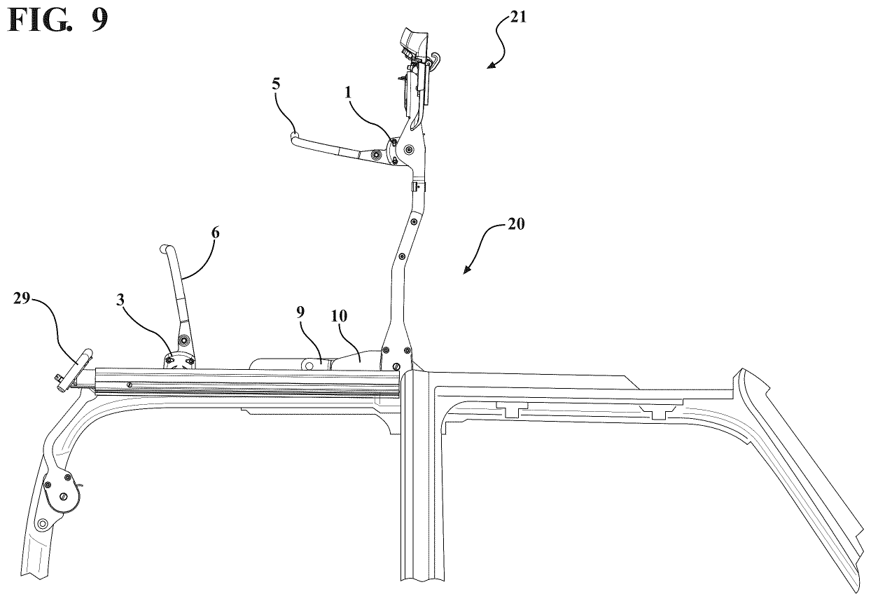

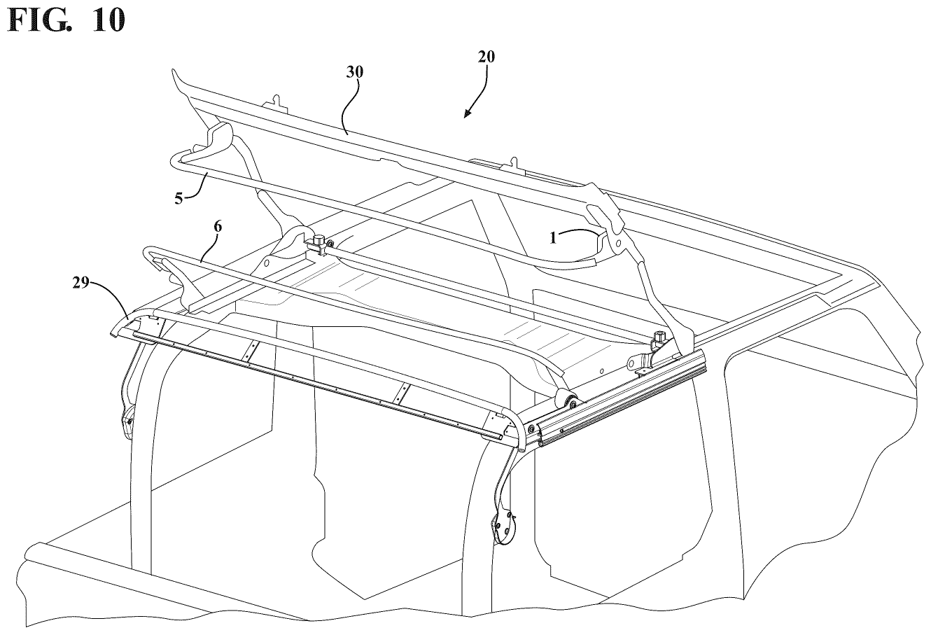

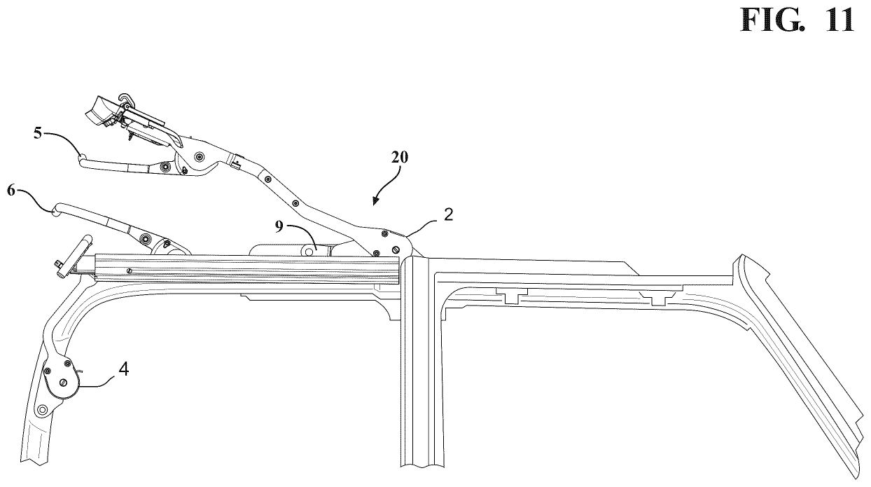

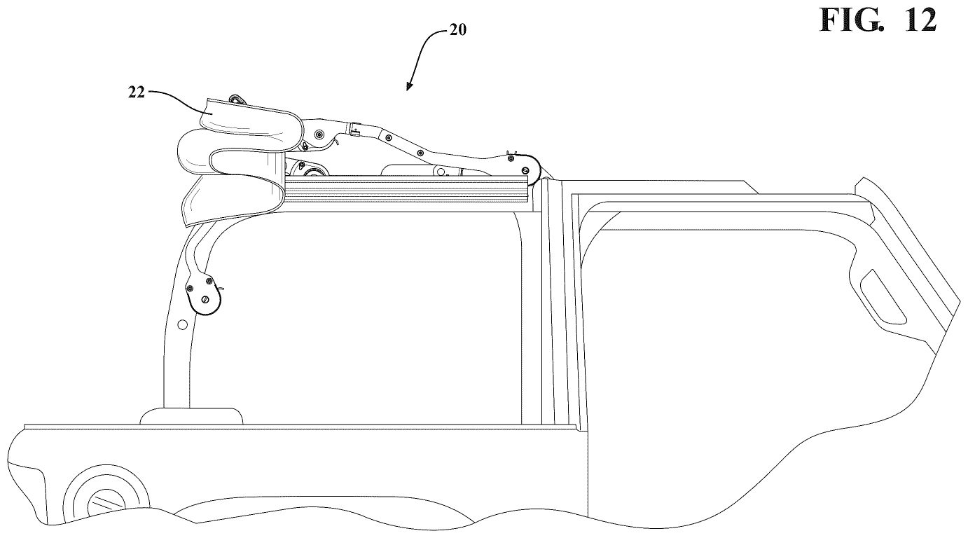

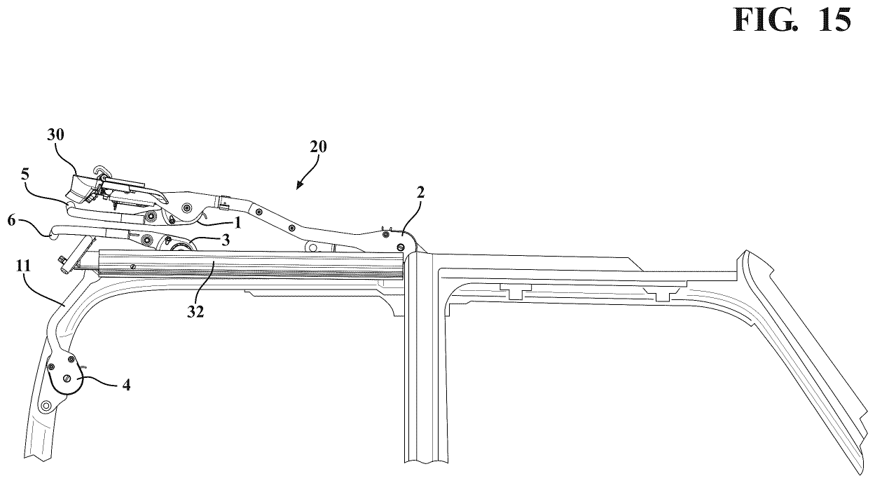

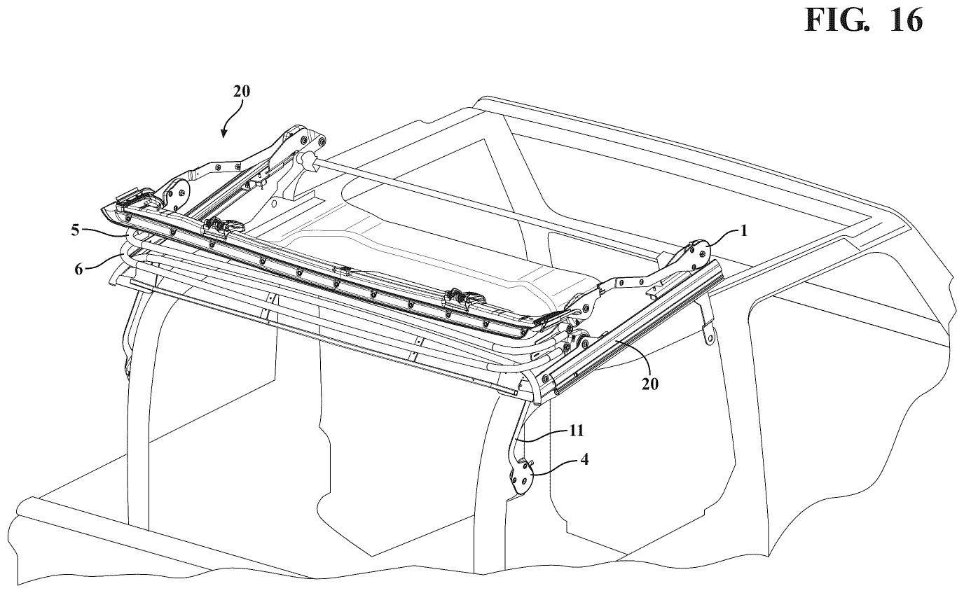

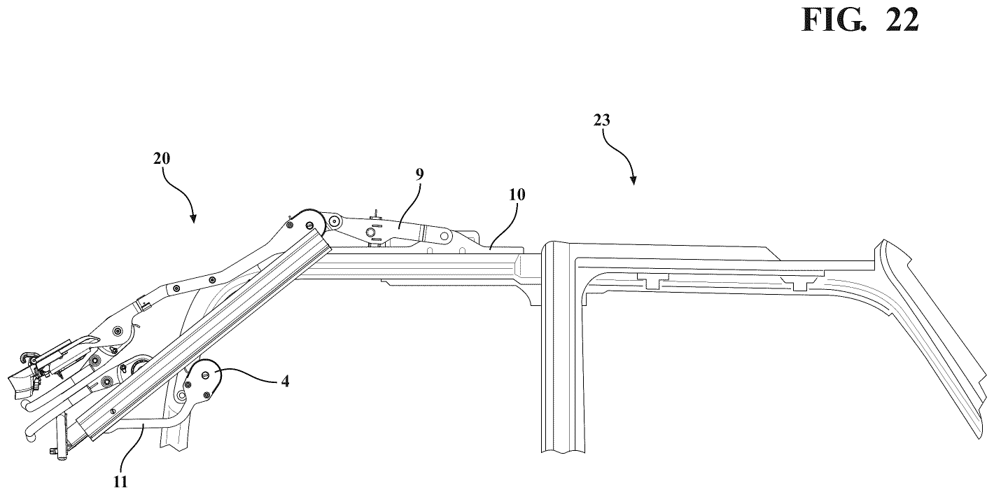

FIGS. 1-5 and 24-28 depict the assembly 20 in a closed position. FIGS. 6-7 depict the assembly 20 opening from the closed position. FIGS. 12-15 and 29-20 depict the assembly 20 in the exemplary open sunroof position. FIGS. 16-22 and 35 depicts the assembly 20 moving into the stowed position. FIG. 22 depicts the stowed position. FIGS. 31-34 depict exemplary clock spring for biasing pivots 1-4.

A cam operable to collapse the top to the open sunroof position is contemplated depending on the application without departure from the scope of the present invention. According to aspects of the present invention, the fabric may be at least partially operably trapped in a sleeve so as the top is brought down (to closed) it stretches it out but when the top is brought back up (to opened) fabric is managed.

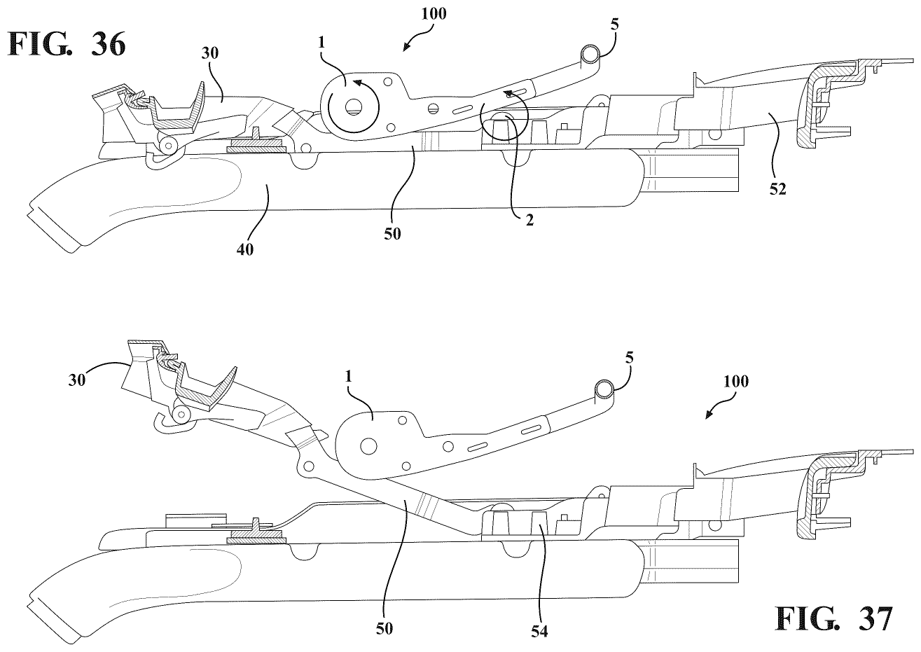

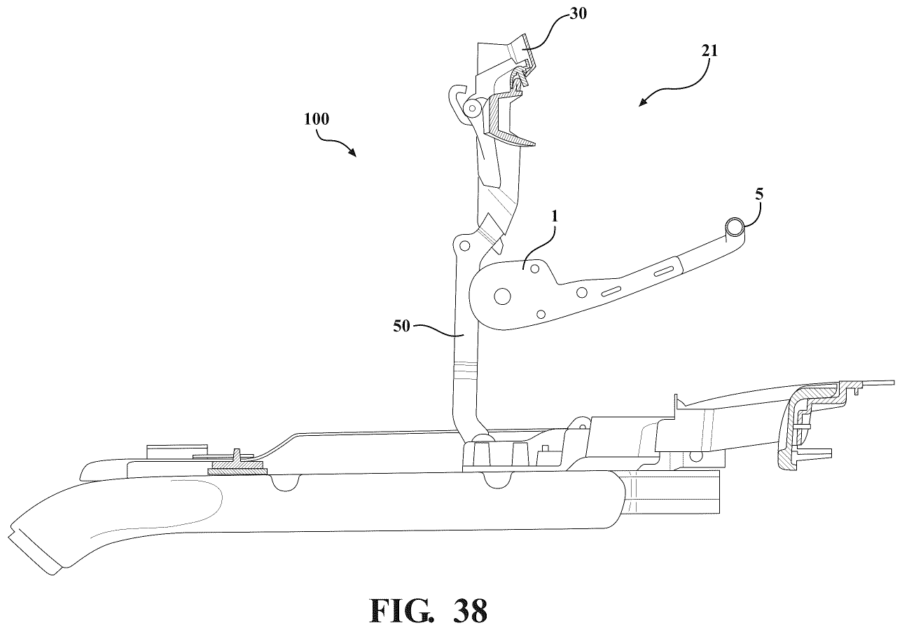

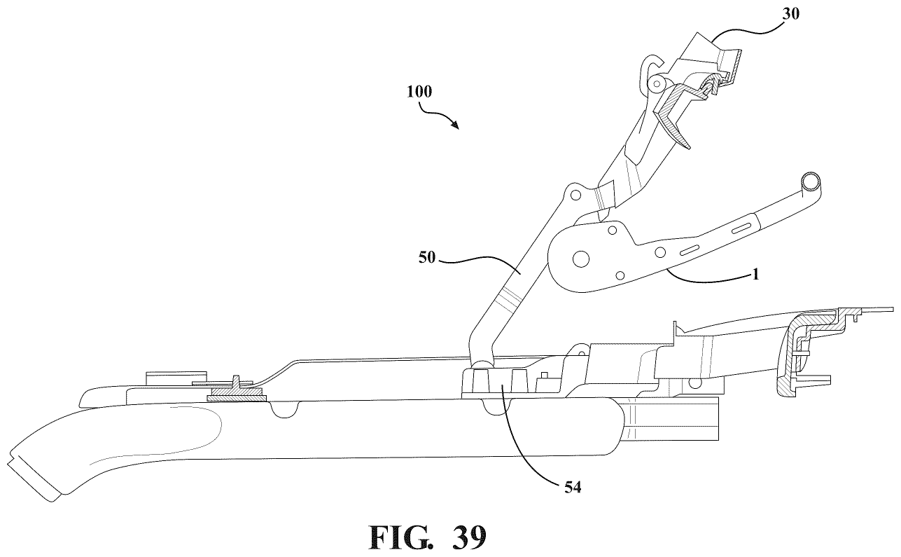

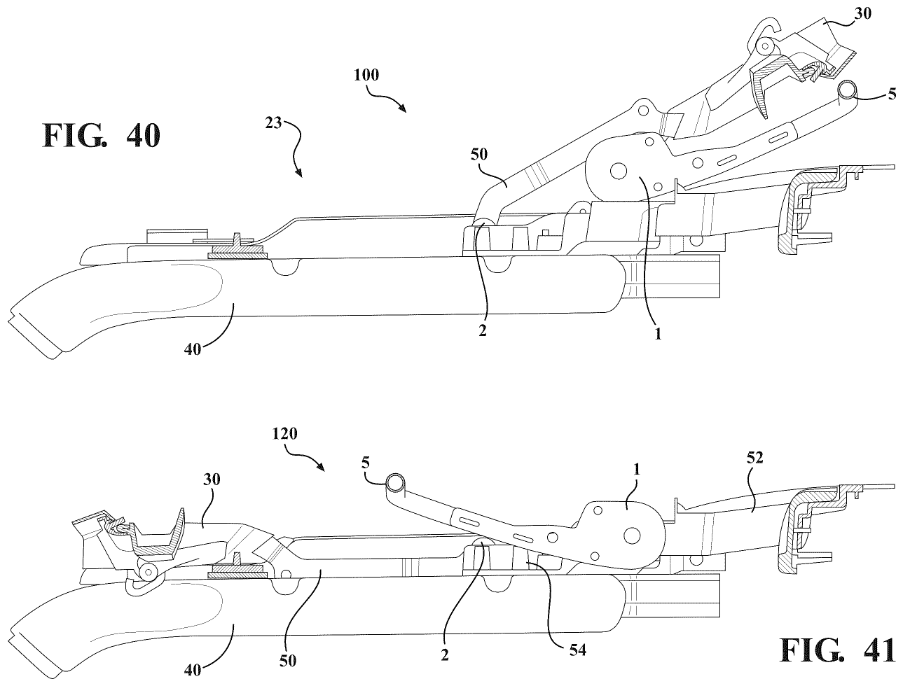

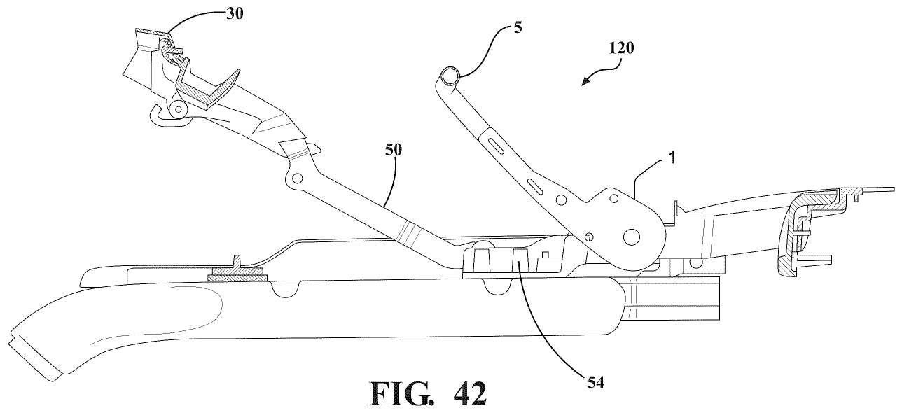

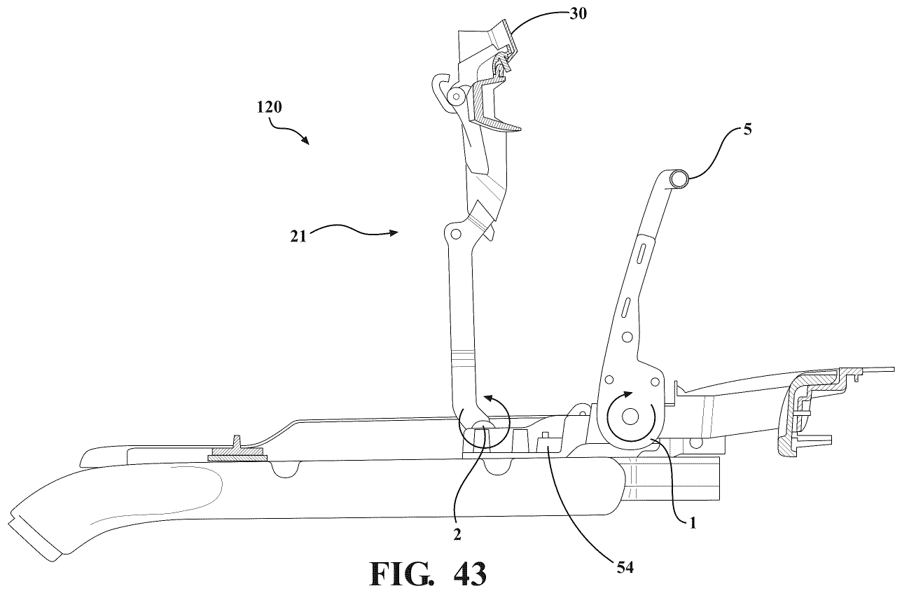

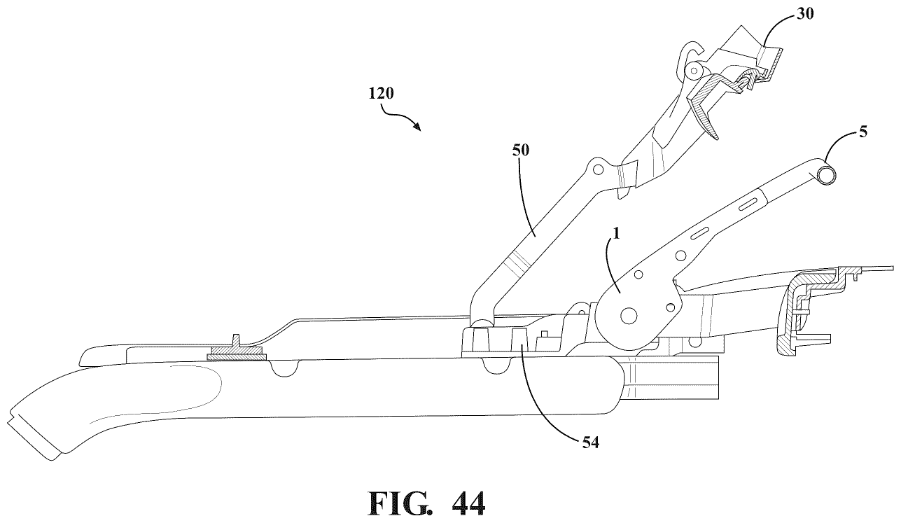

Referring to the Figures generally, and more particularly to FIGS. 36-45, the soft top assembly is operably adapted for engagement with a hardtop of a vehicle, and the system opens to at least the open sunroof position. The soft top assembly is operably adapted to selectively close off a predetermined roof top opening 23 of a vehicle 25, e.g., front cockpit, and open to at least the open sunroof position. Preferably, the soft top assembly is operably kept open even with no catch to hold the soft top in the sunroof open position.

Referring more particularly to FIGS. 36-40, the fabric management soft top assembly 100 is operably adapted for operable engagement with a hardtop of a vehicle, e.g., SUV. The top assembly 10 includes the pivotable portion 21 including the at least one pivot 1 operably rotatably coupled to the arm 50, e.g., front rail. The bow 5, e.g., fabric management bow, is operably coupled to the pivot 1 member between the pair of arms 50,50.

FIG. 36 depicts the assembly 100 in the exemplary closed position operably adapted to couple to the vehicle, e.g., a plurality of selectively releasable latches to a windshield frame, in accordance with aspects of the present invention. Preferably, at least one rear header or halo 52 is operably adapted for sealing engagement with the hardtop of the vehicle, e.g., incorporating seals.

Pivot 1 is provided incorporating a clock spring for biasing the pivot joint. By way of example, the arm 50 has the pivot 1 on either side (or preferably both sides) which each have a clock spring biasing generally in the direction of the arrows, e.g., in the same direction as the rotation joint 2 of the arm 50. Pivot 2 preferably incorporates a clock spring biasing the pivot joint. According to aspects of the present invention, the pivots 1 and 2 on either side (or preferably both) can all have a clock spring biasing generally in the direction of the arrows, e.g., in the same direction. Each arm is operably coupled to a base 54, which base is operably connected to the vehicle 25, and the header 30 is operably connected between the other end of the pair of arms 50.

At rest, the bow 5 is biased away from the front or rear header 30 or 52. Alternatively, toward the header 30. Alternatively, the clock springs may be biased in opposite directions. The clock springs 42 interact with respective predetermined loads. Alternative configurations, combinations, and biasing direction(s) are contemplated without departure from the scope of the present invention. The bias maintains tension of the cover 22, and the bow 5 manages the fabric when folding to the open sunroof position.

A cam to collapse the top to the open position is contemplated depending on the application without departure from the scope of the present invention. According to aspects of the present invention, the fabric may be operably trapped in a sleeve so as the top is brought down (to closed) it stretches it out but when the top is brought back up (to opened) fabric is managed.

A further understanding may be gleaned from FIGS. 1-35 and previous description.

The assembly 100 and FIGS. 36-40 is operably adaptable for any SUV roof-top opening and in combination with any aspects of FIGS. 1-35 and 41-45 and descriptions.

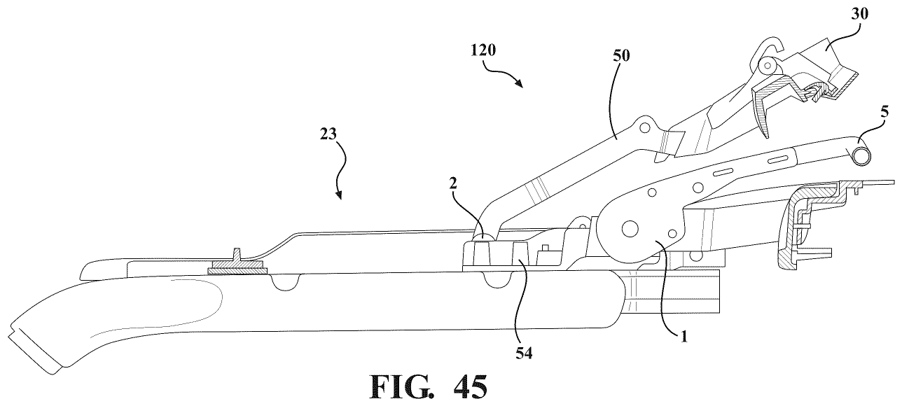

Referring to FIGS. 41-45 generally, there is provided a soft top assembly 120 operably adapted for a vehicle, e.g., SUV, similar to FIGS. 36-40 but with the pivot 1 member with the bow 5 on the base 54 rather than on the arm 50. Preferably, the pivots 1 and 2 are biased in opposite directions with respect to each other, in accordance with aspects of the present invention. FIG. 41 is a side elevation view of a soft top assembly 120 including the pivot 1 member operably connected to the base 54, said soft top assembly 120 depicted in an exemplary closed position operably adapted to couple to the vehicle, e.g., to a windshield frame. FIG. 45 is the soft top assembly of FIG. 41 with the top assembly 120 in the exemplary open position, according to aspects of the present invention. The cover 22 may be kept taught and compresses the back spring, e.g., pivot 1, as it goes back (e.g., to the open sunroof position).

A further understanding may be gleaned from FIGS. 1-40 and previous descriptions.

The assembly 120 and FIGS. 41-45 is operably adaptable for any SUV roof-top opening and in combination with any aspects of FIGS. 1-40 and previous explanations.

Referring to FIGS. 1-45 generally, alternative suitable biasing mechanisms to clock springs are contemplated without departure from the scope of the present invention.

Referring to FIGS. 1-45 generally, it is understood that while a two-door sport utility vehicle (SUV) is depicted, the soft top assembly is operably adapted for 4-door sport utility vehicles and any SUV, e.g., SUV including or not including front and/or rear sport bars, roll bars, etc. The soft top assembly is operably adapted to selectively open up any predetermined roof top opening to the vehicle, and operably adapted to selectively open to a plurality of predetermined roof top opening positions, e.g., sunroof, rear seating, at least partial cargo area, etc.

It is understood that the right side of the soft top assembly is preferably substantially a mirror image to the left side of the soft top assembly.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A soft top assembly adapted for operably connecting to a vehicle, comprising:
at least two fabric management bows;
a plurality of operably biased pivots, operable to dampen the movement of the soft top assembly and provide a lift assist when selectively moving between at least a closed position, sunroof open position, open stowed position and back;
wherein said assembly is operably adapted for sealing engagement with the vehicle.

2. The soft top assembly of claim 1, further comprising at least one pair of front rails operably connected to a front bow connectable to the vehicle in the closed position.

3. The soft top assembly of claim 2, wherein the plurality of operable biased pivots include a pair of first pivots connected to the front rails.

4. The soft top assembly of claim 2, wherein said plurality of operable biased pivots include a pair of first pivots and a pair of second pivots connected to the pair of front rails.

5. The soft top assembly of claim 1, wherein one of said fabric management bows is operably connected to said plurality of operable biased pivots and manages a fabric cover when folding to the sunroof open position.

6. The soft top assembly of claim 1, wherein the plurality of operable biased pivots includes at least a pair of first pivots connected to a pair of front rails movable with a pivotable portion to a said sunroof open position, and a pair of second pivots operably coupled to a pair of rear rails.

7. The soft top assembly of claim 1, wherein said plurality of operable biased pivots are operably connected to said at least two fabric management bows, respectively.

8. The soft top assembly of claim 1, wherein said plurality of operable biased pivots incorporate clock spring biasing.

9. The soft top assembly of claim 1, wherein when said soft top assembly is at rest, said plurality of fabric management bows are biased away from each other.

10. The soft top assembly of claim 1, further comprising a four-bar linkage system substantially forming a parallelogram operable to move said soft top assembly to the open stowed position.

11. The soft top assembly of claim 1, wherein said plurality of operably biased pivots comprises:
a first pivot on at least one side operably connected to a first of said at least two fabric management bows;
a second pivot on at least one side operably connected to a first of a pair of front rails;
a third pivot on at least one side operably connected toward a rear roof top of the vehicle; and
a fourth pivot on at least one side operably connected to the vehicle and to a rear arm,
wherein a pivotable portion of said soft top assembly when in the open sunroof position is pushed substantially upward and tilts back on the first and third pivots while the second pivot dampens the movement, and also provides an assist when closing; and
wherein pushing further moves the top assembly to the stowed position as the fourth pivot biases the top substantially back and downward.

12. The soft top assembly of claim 11, wherein said first pivot goes over center operable to lock the soft top assembly in the open sunroof position and prevents the top from going backward until upward pressure is placed on the frame and then the whole unit pivots back with assist.

13. The soft top assembly of claim 1, further comprising at least one pair of straps operably connecting said plurality of fabric management bows.

14. The soft top assembly of claim 1, further comprising a pair of front rails operably connected to a fabric-tensioning header.

15. A soft top assembly adapted for connecting to a vehicle, comprising:
a cover;
at least one fabric management bow;
a plurality of operably biased pivots, operable to dampen the movement of the soft top assembly and provide a lift assist when selectively moving between at least a closed position and sunroof open position and back;
wherein said assembly is operably adapted for sealing engagement with a hardtop roof top.

16. The soft top assembly of claim 15, further comprising a pair of front rails operably connected to a header and said plurality of operably biased pivots.

17. The soft top assembly of claim 15, wherein said plurality of operably biased pivots are operably connected to a pair of front rails and also to said at least one fabric management bow.

18. The soft top assembly of claim 15, further comprising a pair of front frames operably connected to the vehicle, wherein said plurality of operably biased pivots are operably connected to said pair of front frames, wherein said at least one fabric management bow manages the cover when folding to the sunroof open position.

19. The soft top assembly of claim 15, wherein said plurality of operably biased pivots are biased in opposite directions with respect to each other to maintain the cover tension, and a first pair of said plurality of operably biased pivots are operably connected adjacent both ends of said at least one fabric management bow and manages the cover when moving between the closed and open sunroof positions.

20. A fabric management soft top assembly adapted for operably connecting at a roof top opening to a sport utility vehicle, comprising:
at least two fabric management bows, wherein said fabric management soft top assembly is linkage free between said at least two fabric management bows;
a plurality of biased pivots incorporating springs located on opposing sides of the soft top assembly,
wherein the springs of two of said pivots on each opposing side of the top are biased away from each other to load the said fabric management bows, and when the top is opening, said bows manage the fabric;
wherein the spring of another pivot on each opposing side of the top is biased toward closing the top in order to dampen the fall of the top into an open sunroof position, and to assist the top balance when closing to a closed position; and
wherein springs of one other pivot on each opposing side of the top is biased to assist in closing the top from a full open downward position, simplifying the process of raising the top back up to a top of the vehicle.
